(19) United States
(12) Patent Application Publication
(10) Pub. No.: US 2015/0186722 A1
(43) Pub. Date: Jul. 2, 2015

(54) APPARATUS AND METHOD FOR EYE TRACKING

(71) Applicant: SAMSUNG ELECTRO-MECHANICS CO., LTD., Suwon-Si (KR)

(72) Inventors: Young Jin Cho, Suwon-si (KR); Sun Kyu Lee, Suwon-si (KR)

(73) Assignee: SAMSUNG ELECTRO-MECHANICS CO., LTD., Suwon-Si (KR)

(21) Appl. No.: 14/333,122

(22) Filed: Jul. 16, 2014

(30) Foreign Application Priority Data
Dec. 26, 2013 (KR) 10-2013-0164317

(51) Int. Cl. G06K 9/00; G06F 1/32; G06F 3/01; H04N 5/33; H04N 5/235

(52) U.S. Cl. CPC G06K 9/00604; H04N 5/33; H04N 5/2353; G06K 9/00281; G06F 3/013; G06F 1/325

(57) ABSTRACT

There are provided an apparatus and a method for eye tracking. The method for eye tracking includes: determining an eyeball area covering a subject's eyeballs; allowing an infrared beam element to emit light during an exposure time of a light-receiving sensor corresponding to the eyeball area; and tracking a subject's gaze based on reflected light emitted by the infrared beam element and reflected by the subject's eyeballs.

### CROSS-REFERENCE TO RELATED APPLICATION

This application claims the benefit of Korean Patent Application No. 10-2013-0164317 filed on Dec. 26, 2013, with the Korean Intellectual Property Office, the disclosure of which is incorporated herein by reference.

### BACKGROUND

The present disclosure relates to an apparatus and a method for eye tracking.

As optical technology advances, various technological applications are being developed. Eye tracking technology, as a representative technological application, is the fundamental technology for providing a user with a customized augmented reality service through informatization of a user environment as displayed by a mobile terminal.

Recently, attempts have been made to apply such eye tracking technology to mobile terminal environments. In mobile terminal environments, the power management of mobile terminals is a fundamental issue. Accordingly, in applying eye tracking technology to mobile terminals, power management, i.e., reducing power consumption, is a very important consideration.

Such eye tracking technology requires emitting beams of light from an infrared beam element to determine the positions of a subject's eyeballs, based on information of infrared rays reflected in the subject's eyeballs. That is, it is essential to emit light from infrared beam elements for eye tracking.

In mobile environments, power consumed by an infrared beam element when light is emitted therefrom makes up an especially large portion of total mobile terminal power consumption. Therefore, if eye tracking is continuously performed, mobile terminal power consumption is greatly increased by the eye tracking.

Patent Document 1 relates to a gaze tracking system and method for controlling internet protocol TV at a distance, while Patent Document 2 relates to gaze detection apparatus in a camera. However, the inventions disclosed in these related art documents also have the above-described problems.

### RELATED ART DOCUMENTS

(Patent Document 1) Korean Patent Laid-Open Publication No. 2012-0057033

(Patent Document 2) Japanese Patent Laid-Open Publication No. 1996-292362

### SUMMARY

An aspect of the present disclosure may provide an apparatus and a method in which power is efficiently managed by way of reducing the light emission time of an infrared beam element while performing normal eye tracking.

According to an aspect of the present disclosure, a method for eye tracking may include: determining an eyeball area covering a subject's eyeballs; allowing an infrared beam element to emit light during an exposure time of a light-receiving sensor corresponding to the eyeball area; and tracking a subject's gaze based on reflected light emitted by the infrared beam element and reflected by the subject's eyeballs.

The determining of the eyeball area may include: allowing the infrared element to emit light toward the subject; sequentially performing exposure for each of lines of the light-receiving sensor on the subject; and determining the eyeball area based on the reflection light that is emitted by the infrared beam sensor and reflected by the subject's eyeballs.

The determining of the eyeball area may include: determining the eyeball area by extracting facial feature points from the subject.

The allowing of the infrared beam element to emit light may include: checking at least one first line of the light-receiving sensor corresponding to the eyeball area; and allowing the infrared beam element to emit light during an exposure time of the at least one first line.

The allowing of the infrared beam element to emit light may include: restraining the infrared beam element from emitting light during the initial exposure for the light-receiving sensor.

The allowing of the infrared beam element to emit light may include: performing exposure for each of the lines of the light-receiving sensor in a rolling shutter manner; and allowing the infrared beam element to emit light during an exposure time of at least one first line corresponding to a position of the eyeball area.

The tracking of the a subject's gaze may include: allowing first and second infrared beam elements spaced apart from each other to alternately emit beams; and tracking a gaze of the subject's eyeballs based on a difference between a first reflection light that is emitted by the first infrared beam element and reflected by the subject's eyeballs and a second reflection light that is emitted by the second infrared beam element and reflected by the subject's eyeballs.

According to another aspect of the present disclosure, an apparatus for eye tracking may include: a sensor control unit controlling exposure of a light-receiving sensor; an eye tracking unit determining an eyeball area that covers a subject's eyeballs and checking an exposure time of the light-receiving sensor corresponding to the eyeball area; and a LED driving unit driving an infrared beam LED, wherein the eye tracking unit controls the LED driving unit so that the infrared beam LED is driven during the exposure time.

The sensor control unit may perform exposure for each of lines of the light-receiving sensor in a rolling shutter manner.

The eye tracking unit may control the LED driving unit so that the infrared beam LED is driven during exposure times for all of the lines of the light-receiving sensor and determine the eyeball area based on light reflected by the subject's eyeballs.

The eye tracking unit may check at least one line of the light-receiving sensor corresponding to the determined eyeball area and control the LED driving unit so that the infrared beam LED emits light during an exposure time of the at least one line.

The eye tracking unit may control the LED driving unit so that the infrared beam LED does not emit light during other exposure times than the exposure time of the at least one line.

The LED driving unit may drive first and second infrared beam LEDs spaced apart from each other to emit light alternately, and the eye tracking unit may track gaze of the subject's eyeballs based on a difference between a first reflection light that is emitted by the first infrared beam element and reflected by the subject's eyeballs and a second reflection light that is emitted by the second infrared beam element and reflected by the subject's eyeballs.

According to another aspect of the present disclosure, an apparatus for eye tracking may include: an image processing unit extracting facial feature points from a subject to determine an eyeball area; a sensor control unit controlling exposure of a light-receiving sensor; an eye tracking unit checking an exposure time of the light-receiving sensor corresponding to the eyeball area; and a LED driving unit driving an infrared beam LED, wherein the eye tracking unit controls the LED driving unit so that the infrared beam LED is driven during the exposure time.

The sensor control unit may perform exposure for each of lines of the light-receiving sensor in a rolling shutter manner.

The eye tracking unit may control the LED driving unit so that the infrared beam LED is driven during exposure times for all of the lines of the light-receiving sensor and determine the eyeball area based on light reflected by the subject's eyeballs.

The eye tracking unit may check at least one line of the light-receiving sensor corresponding to the determined eyeball area and control the LED driving unit so that the infrared beam LED emits light during an exposure time of the at least one line.

The eye tracking unit may control the LED driving unit so that the infrared beam LED does not emit light during other exposure times than the exposure time of the at least one line.

The LED driving unit may drive first and second infrared beam LEDs spaced apart from each other to emit light alternately, and the eye tracking unit may track gaze of the subject's eyeballs based on a difference between a first reflection light that is emitted by the first infrared beam element and reflected by the subject's eyeballs and a second reflection light that is emitted by the second infrared beam element and reflected by the subject's eyeballs.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a graph illustrating exposure for receiving reflected light for eye tracking in the related art;

FIG. 2 is an image of an example to which the exposure for receiving reflected light shown in FIG. 1 is applied;

FIG. 3 is a block diagram of an apparatus for eye tracking according to an exemplary embodiment of the present disclosure;

FIG. 4 is a block diagram of an apparatus for eye tracking according to another exemplary embodiment of the present disclosure;

FIG. 5 is an image of exposure for receiving reflected light according to an exemplary embodiment of the present disclosure;

FIG. 6 is a graph illustrating the exposure for receiving reflected light in the exemplary embodiment shown in FIG. 5;

FIG. 7 is an image of exposure for receiving reflected light according to another exemplary embodiment of the present disclosure;

FIG. 8 is a graph illustrating the exposure for receiving reflected light in the exemplary embodiment shown in FIG. 7;

FIG. 9 is a flowchart illustrating a method for eye tracking according to an exemplary embodiment of the present disclosure;

FIG. 10 is a flowchart illustrating an example of operation S910 of the method illustrated in FIG. 9; and

FIG. 11 is a flowchart illustrating an example of operation S912 of the method illustrated in FIG. 9.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

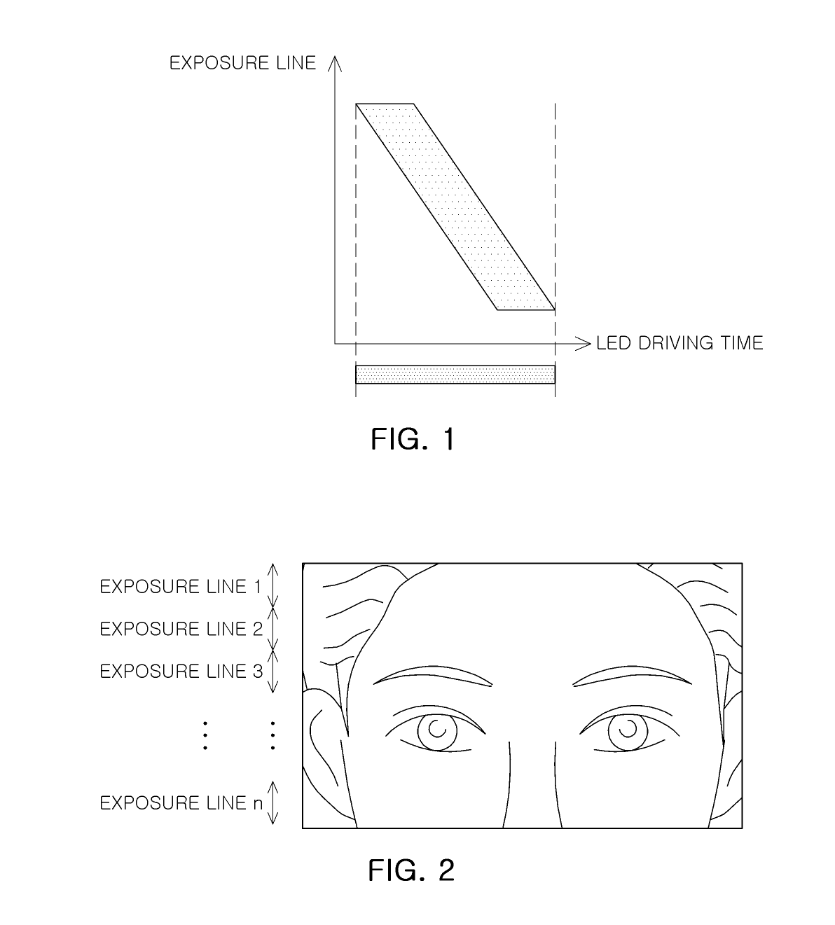

FIG. 1 is a graph illustrating exposure for receiving reflected light for eye tracking in the related art, and FIG. 2 is an image of an example to which the exposure for receiving reflected light shown in FIG. 1 is applied.

As can be seen from FIGS. 1 and 2, an infrared beam LED is driven during the overall exposure times of a light-receiving sensor.

That is, the light-receiving sensor performs exposure on every line (y-lines) to acquire an image. Therefore, the infrared beam LED is driven until the light-receiving sensor completes exposure on the entire image, i.e., all of the y-lines of the light-receiving sensor.

Unfortunately, in this manner, the infrared beam LED is driven even in the areas which are unnecessary for eye tracking, and thus the driving efficiency of the infrared beam LED is low such that power is excessively consumed.

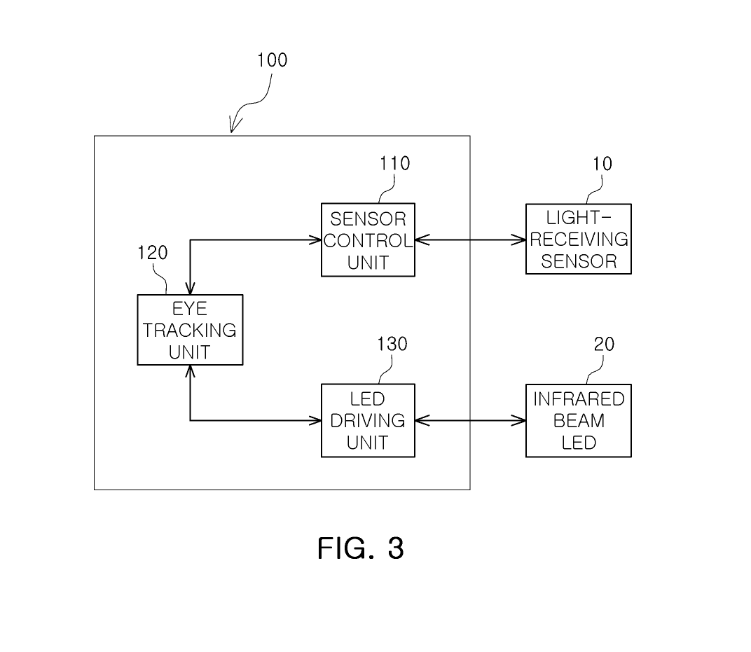

Hereinafter, various exemplary embodiments of the present disclosure will be described with reference to FIGS. 3 through 9. According to various exemplary embodiments of the present disclosure, novel eye tracking technology is proposed that may increase driving efficiency of infrared beam elements such that power consumption is saved. Although an infrared beam LED will be described as an example of the infrared beam element, other elements that emit infrared beams also fall within the scope of the present disclosure.

At first, FIG. 3 is a block diagram of an apparatus for eye tracking according to an exemplary embodiment of the present disclosure. Referring to FIG. 3, the apparatus for eye tracking 100 may include a sensor control unit 110, an eye tracking unit 120, and a LED driving unit 130.

The sensor control unit 110 may control exposure of a light-receiving sensor 10. The sensor control unit 110 may provide the eye tracking unit 120 with such exposure information, e.g., an exposure time for each of lines and an image acquired by the exposure.

In an exemplary embodiment, the sensor control unit 110 may perform exposure for each of the lines of the light-receiving sensor in a rolling shutter manner.

The LED driving unit 130 may drive infrared beam elements. In the following description, an infrared beam LED 20 will be described as an example of the infrared beam elements. The LED driving unit 130 may control light-emitting of the infrared beam LED 20 pursuant to the control of the eye tracking unit 120.

In an exemplary embodiment, the LED driving unit 130 may control the first and second infrared beam LEDs spaced apart from each other so that beams are alternately emitted therefrom, pursuant to the control of the eye tracking unit 120.

The eye tracking unit 120 may determine an eyeball area that covers a subject's eyeballs using the image provided from the sensor control unit 110. The eye tracking unit 120 may check an exposure time of a light-receiving sensor corresponding to the eyeball area and may control the LED driving unit 130 so that the infrared beam LED 20 is driven during the exposure time.

In an exemplary embodiment, the eye tracking unit 120 may drive the infrared ray LED 20 during exposure of all of the lines of the light-receiving sensor at the initial driving for determining the eyeball area. That is, the eye tracking unit 120 may control the LED driving unit 130 so that the infrared beam LED 20 is driven during exposure times for all of the lines of the light-receiving sensor and may determine the eyeball area based on reflection light from the subject's eyeballs. This is because it is necessary to drive the infrared beam LED 20 across the entire image in determining the eyeball area at the initial driving. Once the eyeball area is determined, the eye tracking unit 120 may control the LED driving unit 130 so that the infrared beam LED 20 is driven only during the exposure time corresponding to the eyeball area.

In an exemplary embodiment, the eye tracking unit 120 may determine at least one first line of the light-receiving sensor corresponding to the determined eyeball area and may control the LED driving unit 130 so that the infrared beam LED 20 emits light during exposure time of the at least one first line.

In an exemplary embodiment, the eye tracking unit 120 may control the LED driving unit 130 so that the infrared beam LED 20 does not emit light during the other exposure times than the at least one first line corresponding to the eyeball area.

In an exemplary embodiment, the eye tracking unit 120 may control the LED driving unit so that two infrared beam LEDs spaced apart from each other alternately emit beams and may track gaze of the subject's eyeballs based on a difference between a first reflection light that is emitted by one of the infrared beam LEDs and reflected by the subject's eyeballs and a second reflection light that is emitted by the other one of the infrared beam LEDs and reflected by the subject's eyeballs.

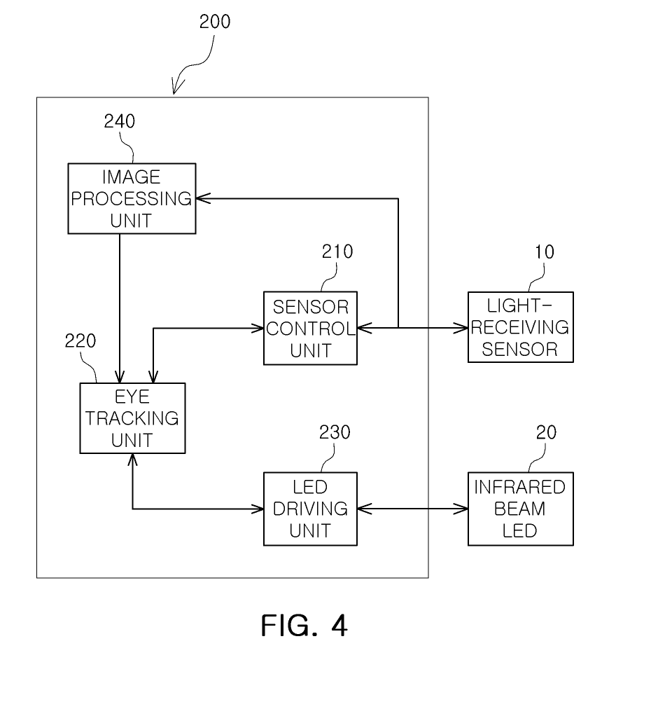

FIG. 4 is a block diagram of an apparatus for eye tracking according to another exemplary embodiment of the present disclosure.

According to this exemplary embodiment shown in FIG. 4, an eyeball area is determined using image recognition technology. Accordingly, the operations of the other elements than an image processing unit 240 are identical to those described above, and thus a redundant description will not be made.

Referring to FIG. 4, an apparatus for eye tracking 200 may include a sensor control unit 210, an eye tracking unit 220, a LED driving unit 230, and the image processing unit 240. In an exemplary embodiment, the sensor control unit 210, the eye tracking unit 220 and the image processing unit 240 may be provided as an IC chip or a plurality of IC chips.

The image processing unit 240 may extract facial feature points of a subject to determine an eyeball area. The image processing unit 240 may use any known image processing technology to determine an eyeball area. The present disclosure is not intended to limit the image processing technology used by the image processing unit 240 to a particular image processing technology. This is because the feature of the image processing unit 240 according to the exemplary embodiment is to specify an eyeball area in an entire image, and the feature may be realized using various image processing technologies.

The image processing unit 240 may provide a determined eyeball area to the eye tracking unit 220. Once the eyeball area is determined, the eye tracking unit 220 may check an exposure time of the light-receiving sensor corresponding to the eyeball area and may control the LED driving unit 230 so that the infrared LED 20 is driven during the exposure time.

In an exemplary embodiment, the sensor control unit 210 may perform exposure for each of the lines of the light-receiving sensor in a rolling shutter manner.

In an exemplary embodiment, the eye tracking unit 220 may determine at least one first line of the light-receiving sensor corresponding to the determined eyeball area and may control the LED driving unit 130 so that the infrared beam LED 20 emits light during the exposure time of the at least one first line.

In an exemplary embodiment, the eye tracking unit 220 may control the LED driving unit 130 so that the infrared beam LED 20 does not emit light during the other exposure times than the at least one first line corresponding to the eyeball area.

In an exemplary embodiment, the LED driving unit 230 may control the first and second infrared LEDs spaced apart from each other so that beams are alternately emitted therefrom, pursuant to the control of the eye tracking unit 220. The eye tracking unit 220 may control the LED driving unit so that the two infrared beam LEDs spaced apart from each other alternately emit beams and may track gaze of the subject's eyeballs based on a difference between a first reflection light that is emitted by one of the infrared beam LEDs and reflected by the subject's eyeballs and a second reflection light that is emitted by the other one of the infrared beam LEDs and reflected by the subject's eyeballs.

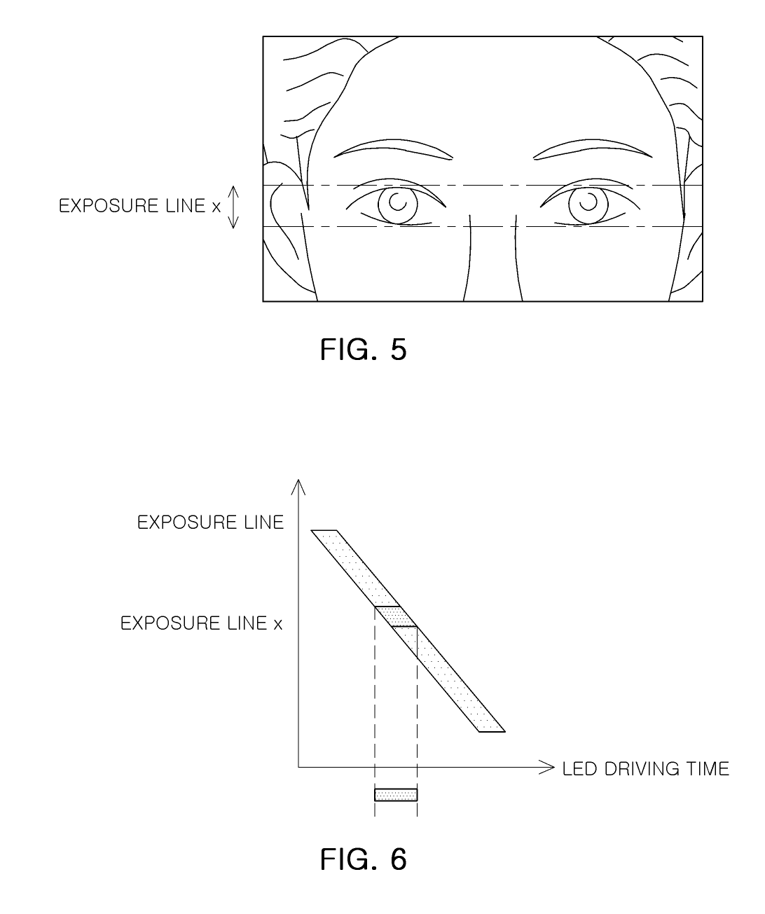

FIG. 5 is an image of exposure for receiving reflected light according to an exemplary embodiment of the present disclosure, and FIG. 6 is a graph illustrating the exposure for receiving reflected light in the exemplary embodiment shown in FIG. 5. In the example shown in FIGS. 5 and 6, imaging is performed in the horizontal direction.

As can be seen from FIG. 5, an eyeball area lies in an exposure line x. Accordingly, the eye tracking unit 220 may control the LED driving unit 230 so that the infrared LED is driven only during the driving time a corresponding to the exposure line x.

By doing so, unlike the infrared LED in the related art which are driven while an entire image is acquired, the infrared LED according to the exemplary embodiment is driven only while the image of the eyeball area is acquired. As a result, the driving time of the infrared LED may be significantly shortened.

When this exemplary embodiment is practiced in a mobile terminal, assuming that the typical imaging distance of a face ranges from 30 cm to 100 cm, the portion of eyes to the entire image is 10% or less. Therefore, according to the exemplary embodiment, the infrared LED is not driven for approximately 90% of the entire time and thus power consumption by the infrared beam LED may be saved by approximately 90%.

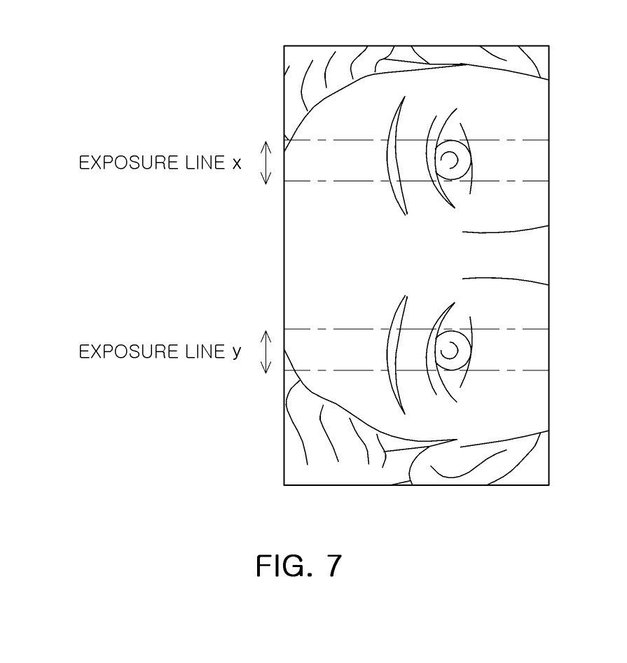

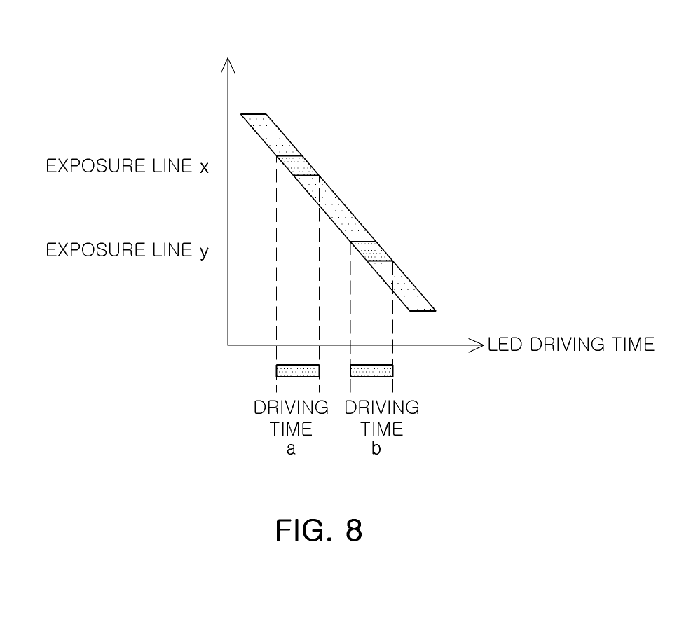

FIG. 7 is an image of exposure for receiving reflected light according to another exemplary embodiment of the present disclosure, and FIG. 8 is a graph illustrating the exposure for receiving reflected light in the exemplary embodiment shown in FIG. 7. In the example shown in FIGS. 7 and 8, imaging is performed in the vertical direction.

In the shown example, imaging is performed in the vertical direction. In this example, an eyeball area may be normally detected as well. In this example, however, the eyeball area consists of two exposure lines in the y-axis direction, and accordingly the eye tracking unit 220 may control the LED driving unit 230 so that the infrared beam LED is driven during exposure times a and b corresponding to the two exposure lines x and y, respectively.

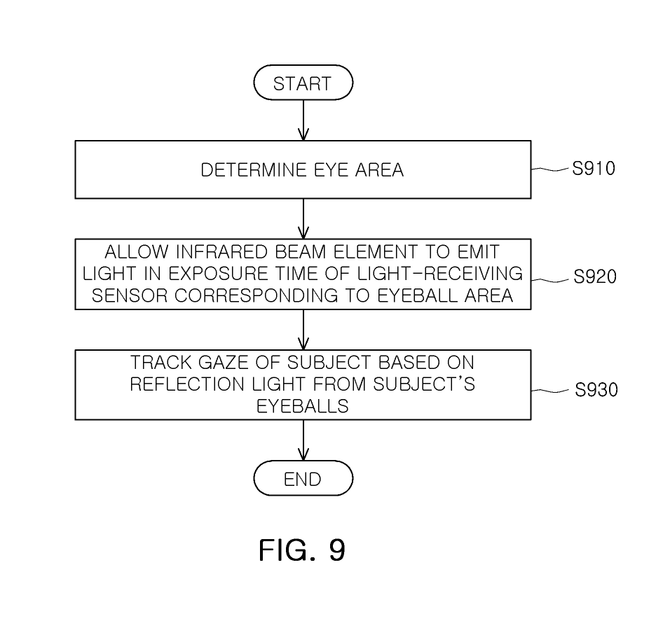

Now, a method for eye tracking according to an exemplary embodiment of the present disclosure will be described with reference to FIG. 9. The method for eye tracking is performed by the apparatuses for eye tracking described above with reference to FIGS. 3 through 8, and thus redundant descriptions on the like elements will not be made.

FIG. 9 is a flowchart illustrating a method for eye tracking according to an exemplary embodiment of the present disclosure. Referring to FIG. 9, the apparatus for eye tracking 200 may determine an eyeball area that covers eye balls of a subject (S910).

Then, the apparatus for eye tracking 200 may allow an infrared beam element to emit light during an exposure time of a light-receiving sensor corresponding to the eyeball area (S920).

Then, the apparatus for eye tracking 200 may track a subject's gaze based on reflection light that is emitted by the infrared beam element and reflected by the subject's eyeballs (S930).

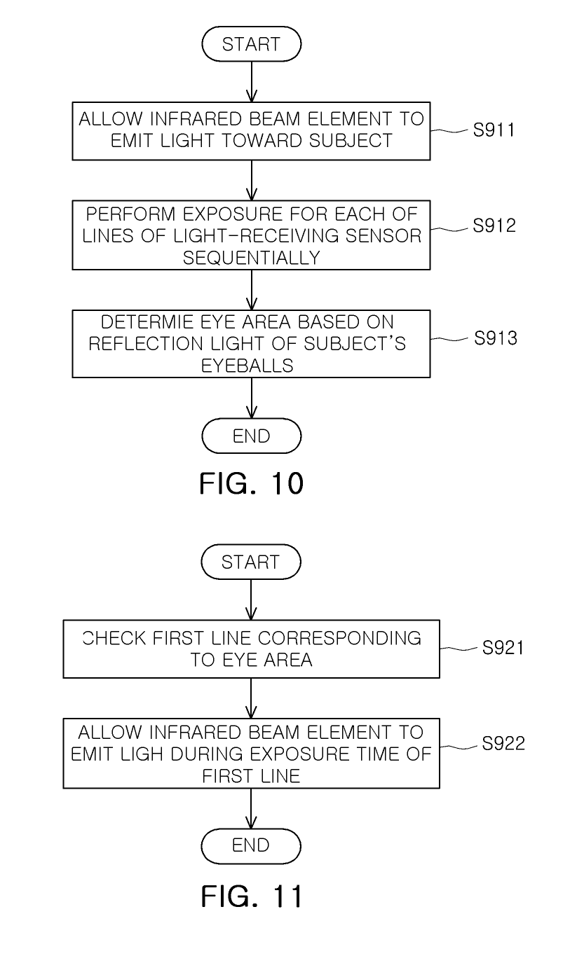

FIG. 10 is a flowchart illustrating an example of operation S910 of the method illustrated in FIG. 9. Referring to FIG. 10, the apparatus for eye tracking 200 may allow the infrared beam element to emit light toward a subject (S911) and may perform exposure sequentially for each of lines of the light-receiving sensor (S912) on the subject. The apparatus for eye tracking 200 may allow the infrared beam element to emit light until exposure on all of the lines of the light-receiving sensor is completed. Then, the apparatus for eye tracking 200 may determine an eyeball area based on reflection light that is emitted by the infrared beam element and reflected by the subject's eyeballs (S913).

In another example of operation S910, the apparatus for eye tracking 200 may extract facial feature points of a subject to determine an eyeball area. That is, the apparatus for eye tracking 200 may determine an eyeball area by using an image processing technique. When such an image processing technique is used, the apparatus for eye tracking 200 may keep the infrared beam element from emitting light.

FIG. 11 is a flowchart illustrating an example of operation S912 of the method illustrated in FIG. 9. Referring to FIG. 11, the apparatus for eye tracking 200 may check at least one first line of the light-receiving sensor corresponding to the eyeball area (S921). Then, the apparatus for eye tracking 200 may allow the infrared beam element to emit light during the exposure time of the at least one first line (S922).

In an example of operation S920, the apparatus for eye tracking 200 may keep the infrared beam element from emitting light at the time of initiating exposure for the light-receiving sensor.

In an example of operation S920, the apparatus for eye tracking 200 may perform exposure for each of the lines of the light-receiving sensor in a rolling shutter manner. Then, the apparatus for eye tracking 200 may allow the infrared beam element to emit light during the exposure time of the at least one first line corresponding to the position of the eyeball area.

In an example of operation S930, the apparatus for eye tracking 200 may allow first and second infrared beam elements spaced apart from each other to alternately emit beams. Then, the apparatus for eye tracking 200 may track gaze of the subject's eyeballs based on a difference between a first reflection light that is emitted by the first infrared beam element and reflected by the subject's eyeballs and a second reflection light that is emitted by the second infrared beam element and then is reflected in the subject's eyeballs.

As set forth above, according to exemplary embodiments of the present disclosure, an infrared beam element is driven to emit light during an exposure time corresponding to a subject's eyeballs on an entire image, such that emission time of the infrared beam element is reduced while performing eye tracking normally, thereby efficiently managing power.

While exemplary embodiments have been shown and described above, it will be apparent to those skilled in the art that modifications and variations could be made without departing from the spirit and scope of the present disclosure as defined by the appended claims.

What is claimed is:

1. A method for eye tracking, comprising:
determining an eyeball area covering a subject's eyeballs;
allowing an infrared beam element to emit light during an exposure time of a light-receiving sensor corresponding to the eyeball area; and
tracking a subject's gaze based on reflected light emitted by the infrared beam element and reflected by the subject's eyeballs.

2. The method of claim 1, wherein the determining of the eyeball area includes:
allowing the infrared element to emit light toward the subject;
sequentially performing exposure for each of lines of the light-receiving sensor on the subject; and
determining the eyeball area based on the reflection light that is emitted by the infrared beam sensor and reflected by the subject's eyeballs.

3. The method of claim 1, wherein the determining of the eyeball area includes: determining the eyeball area by extracting facial feature points from the subject.

4. The method of claim 2, wherein the allowing of the infrared beam element to emit light includes:
checking at least one first line of the light-receiving sensor corresponding to the eyeball area; and
allowing the infrared beam element to emit light during an exposure time of the at least one first line.

5. The method of claim 4, wherein the allowing of the infrared beam element to emit light includes: restraining the infrared beam element from emitting light at the time of initiating exposure for the light-receiving sensor.

6. The method of claim 1, wherein the allowing of the infrared beam element to emit light includes:
performing exposure for each of the lines of the light-receiving sensor in a rolling shutter manner; and
allowing the infrared beam element to emit light during an exposure time of at least one first line corresponding to a position of the eyeball area.

7. The method of claim 1, wherein the tracking of the a subject's gaze includes:
allowing first and second infrared beam elements spaced apart from each other to alternately emit beams; and
tracking a gaze of the subject's eyeballs based on a difference between a first reflection light that is emitted by the first infrared beam element and reflected by the subject's eyeballs and a second reflection light that is emitted by the second infrared beam element and reflected by the subject's eyeballs.

8. An apparatus for eye tracking, comprising:
a sensor control unit controlling exposure of a light-receiving sensor;
an eye tracking unit determining an eyeball area that covers the subject's eyeballs and checking an exposure time of the light-receiving sensor corresponding to the eyeball area; and
a LED driving unit driving an infrared beam LED,
wherein the eye tracking unit controls the LED driving unit so that the infrared beam LED is driven during the exposure time.

9. The apparatus of claim 8, wherein the sensor control unit performs exposure for each of lines of the light-receiving sensor in a rolling shutter manner.

10. The apparatus of claim 8, wherein the eye tracking unit controls the LED driving unit so that the infrared beam LED is driven during exposure times for all of the lines of the light-receiving sensor and determines the eyeball area based on light reflected by the subject's eyeballs.

11. The apparatus of claim 8, wherein the eye tracking unit checks at least one line of the light-receiving sensor corresponding to the determined eyeball area and controls the LED driving unit so that the infrared beam LED emits light during an exposure time of the at least one line.

12. The apparatus of claim 11, wherein the eye tracking unit controls the LED driving unit so that the infrared beam LED does not emit light during other exposure times than the exposure time of the at least one line.

13. The apparatus of claim 8, wherein the LED driving unit drives first and second infrared beam LEDs spaced apart from each other to emit light alternately, and
the eye tracking unit tracks gaze of the subject's eyeballs based on a difference between a first reflection light that is emitted by the first infrared beam element and reflected by the subject's eyeballs and a second reflection light that is emitted by the second infrared beam element and reflected by the subject's eyeballs.

14. An apparatus for eye tracking, comprising:
an image processing unit extracting facial feature points from a subject to determine an eyeball area;
a sensor control unit controlling exposure of a light-receiving sensor;
an eye tracking unit checking an exposure time of the light-receiving sensor corresponding to the eyeball area; and
a LED driving unit driving an infrared beam LED,
wherein the eye tracking unit controls the LED driving unit so that the infrared beam LED is driven during the exposure time.

15. The method of claim 14, wherein the sensor control unit performs exposure for each of lines of the light-receiving sensor in a rolling shutter manner.

16. The method of claim 14, wherein the eye tracking unit controls the LED driving unit so that the infrared beam LED is driven during exposure times for all of the lines of the light-receiving sensor and determines the eyeball area based on light reflected by the subject's eyeballs.

17. The apparatus of claim 14, wherein the eye tracking unit checks at least one line of the light-receiving sensor corresponding to the determined eyeball area and controls the LED driving unit so that the infrared beam LED emits light during an exposure time of the at least one line.

18. The apparatus of claim 17, wherein the eye tracking unit controls the LED driving unit so that the infrared beam LED does not emit light during other exposure times than the exposure time of the at least one line.

19. The method of claim 14, wherein the LED driving unit drives first and second, infrared beam LEDs spaced apart from each other to emit light alternately and
the eye tracking unit tracks gaze of the subject's eyeballs based on a difference between a first reflection light that is emitted by the first infrared beam element and reflected by the subject's eyeballs and a second reflection light that is emitted by the second infrared beam element and reflected by the subject's eyeballs.
